(19) United States
(12) Patent Application Publication
(10) Pub. No.: US 2006/0184429 A1
(43) Pub. Date: Aug. 17, 2006

(54) Method and apparatus for customer-specific creation of entries in a telephone book or the like

(75) Inventor: Michael Oschmann, Nurnberg (DE)

Correspondence Address: LERNER GREENBERG STEMER LLP, P O BOX 2480, HOLLYWOOD, FL, 33022-2480, US

(73) Assignee: Muller Marken GmbH & Co. Betriebs-KG

(21) Appl. No.: 11/353,680

(22) Filed: Feb. 14, 2006

(30) Foreign Application Priority Data
Feb. 14, 2005 (EP) 05 003 112.9

(51) Int. Cl. G06Q 30/00

(52) U.S. Cl. 705/26

(57) ABSTRACT

An efficient, flexible, fail-safe and customer-friendly method is specified for customer-specific creation of entries in a compilation, such as a telephone book or the like, as well as an associated device. At least one customer data record is transmitted from a central core database to a mobile presentation system for a number of preconfigured entry prototypes to be produced on the basis of stored entry templates taking into account the customer data record, and to be displayed on the presentation system for selection. The presentation system generates a corresponding order in order to produce the entry in the telephone book or the like on selection of an entry prototype.

### BACKGROUND OF THE INVENTION

### Field of the Invention

The invention relates to a method for customer-specific creation of entries in a telephone book or the like. The invention also relates to an apparatus for carrying out the method. The expression “telephone book or the like” should be understood as meaning not only actual telephone books but also other collections, directories and reference works of addresses, advertisements and/or notices, in which information relating to persons or companies, in particular address details, subject details, opening times etc. are recorded in accordance with a predetermined data structure. The generic term “compilation” will be used in the following.

For telephone book compilation purposes, commercial network subscribers are normally provided with the capability to emphasize associated telephone book entries by special configuration measures over a standard telephone book entry, for commercial purposes. Configuration measures such as these include, in particular, the use of a font type or size that is not the same as the standard text in the telephone book, the use of graphics elements, the inclusion of additional information such as opening times, or the capability to provide a freely variable advertisement in a predetermined subject area of the telephone book. Advertising entries in telephone books such as these are frequently produced by a large number of media advertisers, working externally, on contract to a publishing house dealing with the production of the telephone book.

The creation of telephone book entries based on an information activity such as this is highly complex and is correspondingly labor-intensive owing to the need to reach agreement between a large number of those involved, specifically the publishing house, the media advertisers and the customers. In this case, it is necessary to remember, in particular, that an agreement error which would lead to an incorrect telephone book entry results in considerable potential damage owing to the comparatively long period of validity and the widespread use of a telephone book, so that this should be avoided in all circumstances. The expression “customers” in this case should be understood as meaning, in general, commercial network subscribers who have already placed orders for the telephone book entries described above or who may potentially place orders.

One specific problem in the creation of telephone book entries is that the information result, that is to say the appearance and the effect of the telephone book entry to be produced, can be shown to the customer only to a limited extent in advance without the amount of labor involved by the media advertisers becoming unacceptable. The information result is in general illustrated only on the basis of a limited number of pre-prepared standard entries. The large number of individual refinement options for the telephone book entry to be produced can so far be described only in an abstract form, however, in general by the media adviser. This frequently complicates customer-specific optimization of the telephone book entry to be produced.

### SUMMARY OF THE INVENTION

It is accordingly an object of the invention to provide a method for customer-specific creation of entries in a compilation which overcomes the above-mentioned disadvantages of the heretofore-known devices and methods of this general type and which allows particularly rational, flexible, fail-safe and customer-friendly creation of entries in a telephone book or the like for the purposes of an information activity such as this. It is a further object of the invention to specify a device which effectively assists the implementation of the system that implements the method mentioned above. With the foregoing and other objects in view there is provided, in accordance with the invention, a method for customer-specific creation of entries in a compilation (e.g., a telephone book or the like), the method which comprises:

transmitting at least one customer data record from a central core database to a remote presentation system;

producing a plurality of preconfigured entry prototypes taking account of the customer data record on the basis of stored entry templates, and displaying on the presentation system for selection; and

upon selection of one of the entry prototypes, generating, with the presentation system, a corresponding order to produce an entry in the compilation.

In other words, according to the invention, a number of entry prototypes, that is to say various drafts, which have already been preconfigured on a customer-specific basis, of a possible compilation entry can be generated automatically on the basis of stored entry templates and on the basis of a customer data record which is made available from a central core database, and it is possible for these entry prototypes to be displayed for selection to the associated customer on a mobile presentation system in particular in the form of a Notebook or a tablet-PC. For this purpose, the customer data record is transmitted, preferably as a raw data record, from the central core database to the mobile presentation system, so that all of the processing of the customer data, in particular the generation of the entry prototype, takes place locally on the presentation system. However, the customer data can also be preprepared beforehand centrally in an equivalent manner, and can be transmitted in this form to the presentation system. In this case, a cost calculation module is preferably used in the mobile presentation system to calculate associated price details for each entry prototype on the basis of a stored cost table, with these price details then being displayed as additional information on the presentation system for selection.

The selection is made using an electronic shopping basket principle. In this case, a selection module of the mobile presentation system produces an offer relating to an entry prototype selected on a customer-specific basis and displays this such that it can be accepted by the customer. On acceptance, an appropriate order is produced which is reported back to a publishing house headquarters in order to produce the entry in the telephone book or the like. In particular, confirmation of the customer by the issue of an electronic signature is provided for order allocation. The order allocation may, however, also be produced on a paper basis in an equivalent manner.

The method according to the invention and the associated apparatus result in the creation of telephone book entries or the like not only being made flexible but also being rationalized to a major extent. A particularly high degree of customer convenience is achieved in this way at the same time. In particular, the automatic generation of the entry prototypes and their display on the mobile presentation system allow the customer to agree to the entry even before making the appropriate purchasing decision, in a form which corresponds to the final version, or is at least very close to it. This advantageous result is achieved with comparatively little labor involved for the customer adviser at the same time, with the display prototypes being generated automatically on the basis of the centrally stored customer data. The automatic transmission of the centrally stored customer data to the mobile presentation system and the automated data agreement between the customer adviser and the publishing house resulting from this also achieve a particularly high degree of protection against the entry of incorrect data.

In one preferred embodiment, each entry template comprises a number of associated entry fields with which values are associated in the course of creation of the entry prototypes. A variable which is associated with a specific item of customer information and forms a component of the information contained in the entry, in particular the name, address, telephone number, etc. of the customer, is referred to as an entry field. An entry field may in this case also be provided for holding image data, in particular a customer logo or the like.

In this case, a distinction is drawn between required entry fields and optional entry fields. Required entry fields, of which each entry template has at least one, are necessarily associated with this entry template. The required entry fields which are associated with an entry template comprise, for example, a name field and a telephone number field. In addition, it is expedient to provide for one or more optional entry fields to be additionally associated with at least one entry template, which are activated or deactivated as desired by the customer, that is to say they are included in or masked out of the entry prototype. This comprises, for example, information relating to address data, opening times, subject details, freely configurable text lines, or the like.

In the course of the generation of the entry prototypes, the entry fields in the basic entry template are, as a matter of priority, filled with a corresponding customer-specific value, which is defined by the customer data record. However, if an entry field cannot be filled out from the existing customer data, then, in one advantageous refinement of the invention, this entry field is filled with a stored standard value. In order nevertheless to ensure that the contents of the entry prototypes match the final entry as closely as possible, the standard value is preferably selected—to the extent that this is worthwhile—in a subject-specific manner on the basis of subject details which are obtained from the customer data record. In particular, provision is made for a subject-specific logo to be used as a standard value for the situation in which no customer-specific logo is available. A non-specific standard value is preferably used only if no subject-specific standard value is available, either.

In one particularly advantageous refinement of the invention, each entry prototype can be edited in advance of the selection, that is to say before the purchasing decision to be made by the customer on the presentation system. Hence, the customer is provided with the capability to correct incorrect values or to add missing values. In particular, the optional capability is provided to enter a customer logo instead of a standard logo directly into the presentation system and thus to adapt an appropriate entry prototype directly in front of the customer's eyes. Provision is in this case likewise made for optional entry fields to be reversibly included or masked out. The presentation system is in this case designed in such a way that the price details, which may be dependent on the number and/or the nature of the activated optional entry fields, are adapted automatically.

Provision is also expediently made for the customer data record that is used to create the entry prototypes to be updated appropriately once the entry prototypes have been modified. If, by way of example, the customer inserts the opening times, which have not previously been stored in the core database, for his branch into the entry prototypes, then these opening times are automatically transferred to an updated customer data record. This is reported back to the core database in the course of data matching.

In a further refinement of the invention, provision is made for the selection module to offer a number of search terms in addition to the entry prototypes. A search term (or keyword) such as this comprises, in particular, so-called meta information, which is not a visible entry component but is associated as invisible search information with the entry within an electronic directory. In order to simplify the advice and hence also to achieve greater customer convenience, provision is expediently made for the search terms which are displayed by the selection module once again to be selected, in a subject-specific manner, from a terminology memory on the basis of subject information contained in the customer data record.

Copies of the entry templates, standard values as well as the available search terms are expediently stored locally in the presentation system, with these copies expediently being updated at regular intervals from a central template memory, so that the mobile presentation system is also automatically updated to the latest standard in the event of a change to the entry layout, in the event of changes to the costs or the like by the publishing house.

With the above and other objects in view there is also provided, in accordance with the invention, a device for customer-specific creation of entries in a compilation, comprising:

a core database associated with a central data management system and having stored therein a number of customer data records;

a data transmission system for transmission of at least one customer data record from said core database to a remote presentation system;

an entry generator configured to generate a number of preconfigured entry prototypes based on stored entry templates, taking into account the transmitted customer data record or the customer data record to be transmitted; and

a selection module associated with said presentation system and configured to display the preconfigured entry prototypes for selection and, on selection of an entry prototype by said presentation system, to produce a corresponding order for inclusion of the entry in the compilation.

Other features which are considered as characteristic for the invention are set forth in the appended claims.

Although the invention is illustrated and described herein as embodied in a method and apparatus for customer-specific creation of entries in a telephone book or the like, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

One exemplary embodiment of the invention will be explained in more detail in the following text with reference to a drawing, in which:

### BRIEF DESCRIPTION OF THE DRAWINGS

FIG. 1 is a schematic block diagram of a device for customer-specific creation of entries in a telephone book, having a central data management system and a mobile presentation system;

FIG. 2 is a schematic sketch of five entry templates stored in the device shown in FIG. 1; and

FIG. 3 is a schematic illustration of a user interface of the presentation system as shown in FIG. 1, with an entry prototype that is displayed for selection and has been created on the basis of an entry template as shown in FIG. 2.

### DESCRIPTION OF THE PREFERRED EMBODIMENTS

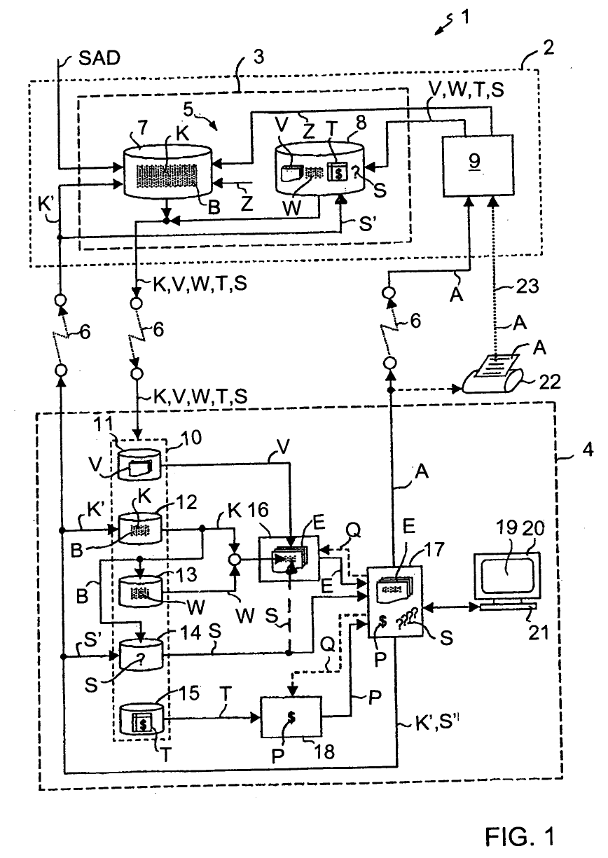

Referring now to the figures of the drawing in detail and first, particularly, to FIG. 1 thereof, there is shown a device 1 for the creation of entries in a telephone book. The device 1 has a central data management system 3 which is associated with a publishing house 2 shown on the figure. The device 1 also has a large number of mobile presentation systems 4, which are each allocated to one media adviser and one example of which is illustrated in FIG. 1.

The central data management system 3 has a computation installation 5 with one or more data servers. The presentation system 4 is in the form of a portable computer, in particular a laptop, a notebook computer, or a tablet-PC, for example. The data management system 3 and each presentation system 4 are connected via a permanent or temporary data transmission system 6, in particular a wire-based or wireless telecommunications link, an Internet link, or the like.

The data management system 3 has a core database 7 in which a large number of customer data records K are stored. Each customer data record K is in this case associated with one commercial subscriber in a telecommunications network. Various types of information relating to the associated network subscriber (referred to in the following text as a customer) are stored in each customer data record K, in particular the name, address, telephone number and a subject designation B associated with each customer. The customer data record may also contain further information such as opening times of a shop, an e-mail or Internet address, image data of a customer logo, or other customer-specific information. A basic element of the information contained in each customer data record K is supplied to the core database 7 by a telecommunications company by means of so-called standard order data SOD. This standard order data SOD contains in particular names, telephone numbers, the subject or professional designation and address details of the network subscribers. The standard order data SOD has additional data Z added to it by the publishing house 2, with this additional data Z having been obtained in the course of current business relationships, from their own research or from other data sources about specific customers.

The central data management system 3 also has a template server 8. A number of entry templates V for telephone book entries are, in particular, stored in the template server 8. The template server 8 also contains a list with standard values W (which will be specified in more detail in the following text), a cost table T and a list of search terms (or keywords) S. The entry templates V, standard values W, the cost table T and the search terms S are maintained in the template server 8 by publishing house headquarters 9, and are updated as required. In particular, the search terms S are organized on a subject-specific basis, that is to say on the basis of subject, and are stored in the template server 8. Subject-relevant search terms S are determined, for example, by Internet searches, statistical evaluation of the requests to on-line directories and search engines, statistical analysis of frequently used search terms in existing orders, customer questions or the like.

The presentation system 4 has a storage module 10, in particular a hard disk. The storage module 10 is functionally subdivided for illustrative purposes in FIG. 1 into a template memory 11 for local storage of copies of the entry templates V, a customer data memory 12 for local storage of a number of customer data records K, a value memory 13 for local storage of copies of the standard values W, a terminology memory 14 for local storage of copies of the search terms S, and a cost memory 15 for storage of a copy of the cost table T.

The presentation system 4 has an entry generator 16 which is designed to automatically generate an associated entry prototype E on the basis of each stored entry template V and taking into account the information contained in a customer data record K as well as standard values W stored for assistance purposes. In this case, the display generator 16 optionally also accesses the terminology memory 14, for example in order to automatically derive proposals for business designations or instructions relating to goods or services on the basis of subject-specific criteria as required from the stored search terms S, and to integrate them in the display prototype E. The presentation system 4 also has a selection module 17 which is designed to display the entry prototypes E, which have been preconfigured by the entry generator 16 with respect to the customer data record K on which they are based, to the associated customer for selection. The selection module 17 feeds back to the entry generator 16 in order to cause it to carry out customer-specific editing of one or more entry prototypes E as required in response to an appropriate request Q. The entry generator 16 and the modules 17 and 18 are preferably in the form of software modules.

The selection made in conjunction with a purchasing decision by the customer is structured in the form of an electronic shopping-basket principle. The selection module 17 is in this case connected to a price calculation module 18 which calculates associated price details P in response to a request Q′ relating to an offer displayed by the selection module 17 and by referring back to the stored cost table T, and supplies these price details to the selection module 17.

The offer which is displayed by the selection module 17 optionally includes, in addition to an entry prototype E that is available for selection, one or more associated search terms S, which are supplied to the selection module 17 from the terminology memory 14. For display purposes and if appropriate in order to modify the offer and to make a selection, the presentation system 4 includes a graphics user interface 19, which corresponds to means for inputting and outputting data, in particular a screen 20, a keyboard 21, a mouse, a touchpad etc., for the presentation system 4.

The selection module 17 is designed to produce an order A where an entry prototype E is selected and, possibly, additional search terms S are selected. After confirmation by the customer, the order A is transmitted by the presentation system A to the publishing house headquarters 9, which produces a telephone book entry corresponding to the order A. The order A is preferably an electronic document. Provision is preferably made for an electronic signature to be issued as the means for customer-end confirmation. However, in an equivalent form, the order A can also be issued via a printer 22 as a paper document, which is transmitted to the publishing house headquarters 9 by mail dispatch 23 or in some similar form after being signed by the customer.

In the course of the creation of a telephone book entry, the customer data record K which corresponds to a predetermined customer is transmitted, in a first step, from the core database 7 to the customer data memory 12 for the presentation system 4. In practice, the issue of commercial telephone book entries is frequently carried out by external media advisers with a fixed geographic area of responsibility, so that the customer data records K which are transmitted to the presentation system 4 allocated to a specific media adviser are selected in particular on the basis of geographic criteria. Furthermore, the copies of the entry templates V, standard values W, search terms S and the cost table T stored in the presentation system 4 are optionally updated by means of the corresponding original data in the template server 8. This updating process is carried out regularly, that is to say at uniform time intervals or else whenever the corresponding data in the template server 8 has been changed.

When a media adviser visits a customer, the respectively associated entry prototypes E are now produced automatically by the entry generator 16 on the basis of the customer data record K associated with this customer, and on the basis of the stored entry templates V.

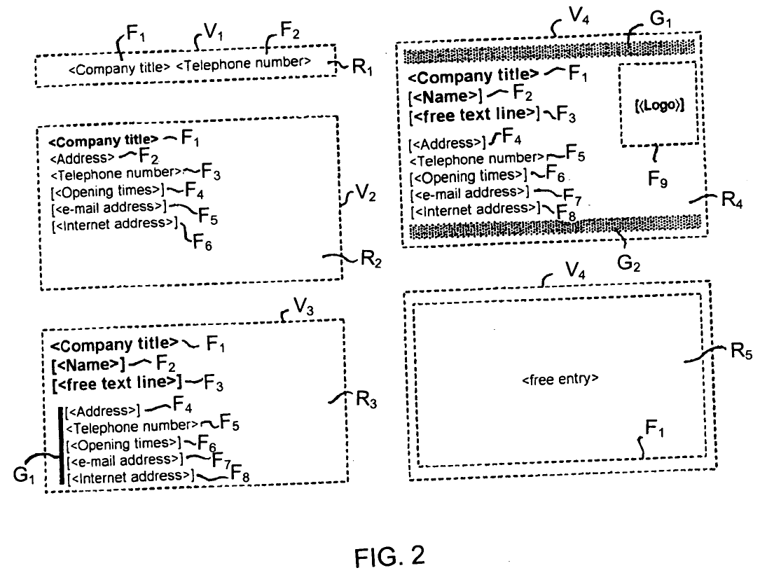

As shown in FIG. 2, five entry templates Vₙ(n=1, 2, . . . , 5) are, by way of example, stored in the template memory 11 and provide the customer to different extents with the capability to produce a representation of the entry in the telephone book which is effective for advertising purposes. Each entry template Vᵢ has a number of associated entry fields Fₘ(m=1, 2, . . . ). The entry fields Fₘ which are associated with the respective entry template Vₙ represent variables, each of which corresponds to one specific information item from the customer data record K. By way of example, the entry field F₁ in the entry template V₁ represents a variable for the company title of the customer, the entry field F₂ represents a variable for the telephone number (or call number) of the customer. In FIG. 2, required entry fields Fₘ, which appear to be necessary in the context of the respective entry template Vₙ and of which each entry template Vₙ has at least one, are shown in pointed brackets (for example [symbol] company title [symbol] ). Optional entry fields Fₘ, which can be included or masked out as the customer desires, are additionally shown in square brackets, for example [ [symbol] Address [symbol] ]. Each entry template Vₙ is additionally assigned format rules Rₙ (n=1, 2, . . . , 5) (which are only indicated in the illustration), which specify the display format and the arrangement of the entry fields Fₘ, the shape and arrangement of graphics elements Gₘ (m=1, 2, . . . ) which may be present, etc.

A corresponding entry prototype Eₙ (n=1, 2, . . . , 5) is generated for each entry template Vₙ, in that, if possible, one value from the customer data record K is assigned to each entry field Fₘ in the respective entry template Vₙ. The entry field F₁ in the entry template V₁ is thus filled with the customer company title contained in the customer data record K, etc. For optional entry fields Fₘ, this is done only to the extent that they are marked as “activated,” that is to say they should be included corresponding to an assigned activation state.

If no corresponding value can be determined for an entry field Fₘ from the customer data record K, then the entry generator 16 fills this entry field Fₘ, instead of this, with a standard value W taken from the standard memory 13. For example, if the customer's Internet address is not stored in the customer data record, the entry field F₈ in the entry template V₃ is filled with the standard value “www.XXX.XX”.

This replacement of the customer-specific information by standard values W is carried out—when worthwhile—on a differential basis in that a subject-specific standard value W is assigned as the priority item to the corresponding entry field Fₘ, with this standard value W being selected from the value memory 13 as a function of the subject details B contained in the customer data record K. A non-specific standard value W is used only if no subject-specific standard value W can be determined. This differential method is applied in particular to the entry field F₉, which is associated with a customer logo, in the entry template V₄. Provision is also optionally made for the entry field F₃, which contains a freely configurable text line, in the entry templates V₃ and V₄ to be filled, as the priority, with subject-specific information if the value for this entry field F₃ is not determined from the customer data record K. In particular, the entry generator 16 accesses the terminology memory 14 for this purpose, in order to generate and to automatically integrate proposals for company titles or instructions relating to goods or services as a function of the subject details B, with the aid of the stored search terms S.

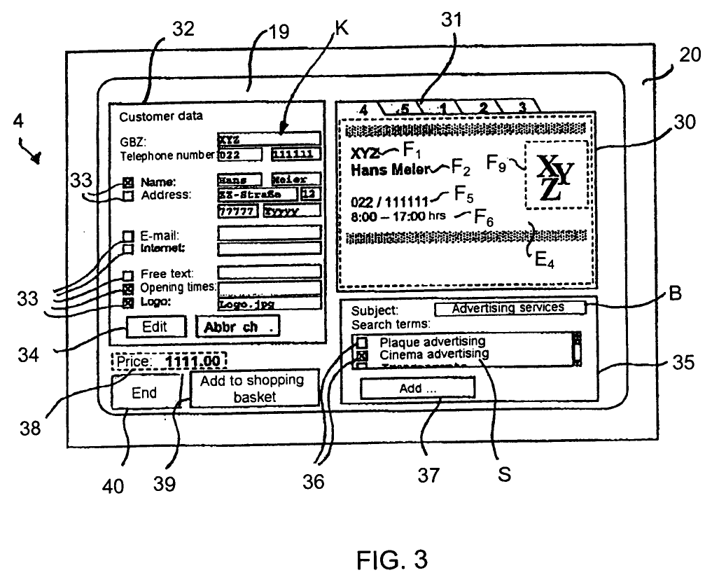

The entry prototypes Eₙ which have been produced in this way are displayed by means of the screen 20 in a display field 30 of the user interface 19, which is illustrated in a simplified schematic form in FIG. 3. In the illustration shown in FIG. 3, the entry field 30 shows the entry prototype E₄. The other entry prototypes E₁, E₂, E₃ and E₅ can be requested via a selection strip 31 which is associated with the display field 30.

As shown in FIG. 3, the user interface 19 also has an entry field 32 in which the values which correspond to the entry fields Fₘ from the customer data record K are displayed. Each optional entry field Fₘ in this case has an associated check box 33, which indicates the activation state of the entry field Fₘ. In the example shown in FIG. 3, the optional entry fields F₂ (name), F₆ (opening times) and F₉ (logo) are marked as being activated. The entry fields F₂, F₆, and F₉ are thus also included in the displayed entry prototype E₄. Those entry fields F₃ (free text line), F₄ (address), F₇ (e-mail address) and F₈ (Internet address) which are marked on the entry template V₄ as being deactivated are in contrast not included in the entry prototype E₄. The entry prototype E₄ illustrated by way of example contains, in particular a customer-specific logo which is contained in the customer data record K in the form of a “logo.jpg” graphics file. The entry field F₆ (opening times), which is not defined from the customer data record K, is filled with the standard value W “0800-1700 hrs”.

The customer data which is displayed within the entry field 32 can be edited by the media adviser. In particular, missing values can be added and incorrect values can be corrected. Furthermore, optional entry fields Fₘ can be reversibly activated or deactivated by operation of the associated check box 33. Every change which is made within the entry field 32 and is confirmed by operation of a button 34 (“edit”) initiates a request Q from the selection module 17 to the entry generator 16, which appropriately modifies the entry prototypes Eₙ. Every change to the customer data made in the entry field 32 is thus transferred directly to the entry prototype Eₙ displayed in the display field 30.

A number of search terms S which are preselected from the terminology memory 14 on the basis of the subject details B contained in the customer data record K are displayed in a further entry field 35 of the user interface 19. Each search term S is in turn associated with a check box 36, which can be operated in order to activate the search term S. In the example shown in FIG. 3, the subject-specific search terms S “plaque advertising”, “cinema advertising”, “transparent”, . . . have been preselected for the “advertising services” subject details B, of which, in turn, only the search term S “cinema advertising” is activated.

Further customer-specific search terms S can be included in the list displayed in the entry field 35 by operation of a button 37 (“add . . . ”).

At the same time that the entry prototypes En and the search terms S are being displayed, in response to a request Q′ from the selection module 17, the price calculation module 18 calculates the price details P taking into account the displayed entry prototype Eₙ, the activation state of the optional entry fields Fₘ and of the activated search terms S, and displays these price details in a further display field 38 of the user interface 19. In this case, the price details P are automatically updated in response to any change relating to the displayed entry prototype Eₙ, the activated entry fields Fₘ or the activated search terms S.

The actual selection is made by operation of a further button 39 (“add to shopping basket”), and relates to the displayed offer, that is to say the displayed entry prototype Eₙ and any search terms S which may be activated. When the button 39 is operated, then the selection module 17 automatically produces the order A which, after being confirmed by the customer, is passed to the publishing house headquarters 9.

Alternatively, the offer is rejected by operation of a button 40. In this case, the offer A is not created.

Irrespective of whether the offer is accepted or rejected, if the customer has changed the customer data, the presentation system 4 feeds back a customer data record K′ which has been updated in accordance with these changes to the local customer data memory 12 and to the central core database 7. Any search terms S′ which may have been added on a customer-specific basis are likewise fed back to the local terminology memory 14 and to the central template server 8.

This application claims the priority, under 35 U.S.C. § 119, of European patent application No. 05 003 112.9, filed Feb. 14, 2005; the entire disclosure of the prior application is herewith incorporated by reference.

I claim:

1. A method for customer-specific creation of entries in a compilation, the method which comprises:
transmitting at least one customer data record from a central core database to a remote presentation system;
producing a plurality of preconfigured entry prototypes taking account of the customer data record on the basis of stored entry templates, and displaying on the presentation system for selection; and
upon selection of one of the entry prototypes, generating, with the presentation system, a corresponding order to produce an entry in the compilation.

2. The method according to claim 1, wherein the remote presentation system is a mobile presentation system.

3. The method according to claim 1, wherein each entry template comprises a plurality of associated entry fields and format rules for a display thereof, wherein each entry template is associated with at least one required entry field, and wherein at least one entry template is additionally associated with at least one optional entry field.

4. The method according to claim 3, which comprises, during a creation of an entry prototype, filling a value associated with an entry field with a standard value, unless the value has been defined by the customer data record.

5. The method according to claim 4, which comprises selecting the standard value in a field of application-pertinent manner from a value memory, and based on field of application details contained in the customer data record.

6. The method according to claim 3, which comprises enabling each entry prototype for editing with respect to the value associated with an entry field, and with respect to an activation state of an optional data field.

7. The method according to claim 6, which comprises automatically updating the customer data record on the basis of the edited entry prototype, and reporting an updated customer data record back to the core database.

8. The method according to claim 1, which comprises calculating price details for each entry prototype on a basis of a stored cost table, and displaying the price details with the presentation system.

9. The method according to claim 1, which comprises displaying a number of search terms for additional selection on the presentation system, wherein the displayed search terms are preselected according to a pertinent field of application from a terminology memory on a basis of subject details contained in the customer data record.

10. The method according to claim 1, which comprises storing a copy of each entry template locally in the presentation system in order to produce the respective entry prototype, and regularly updating the copy or each copy from a central template memory.

11. The method according to claim 10, which comprises storing copies of the standard values locally in the presentation system, and regularly updating the copies from a central template memory.

12. The method according to claim 4, which comprises storing copies of the standard values locally in the presentation system, and regularly updating the copies from a central template memory.

13. The method according to claim 9, which comprises storing copies of the search terms locally in the presentation system, and regularly updating the copies from a central template memory.

14. The method according to claim 10, which comprises storing copies of the search terms locally in the presentation system, and regularly updating the copies from a central template memory.

15. A device for customer-specific creation of entries in a compilation, comprising:
a core database associated with a central data management system and having stored therein a number of customer data records;
a data transmission system for transmission of at least one customer data record from said core database to a remote presentation system;
an entry generator configured to generate a number of preconfigured entry prototypes based on stored entry templates, taking into account the transmitted customer data record or the customer data record to be transmitted; and
a selection module associated with said presentation system and configured to display the preconfigured entry prototypes for selection and, on selection of an entry prototype by said presentation system, to produce a corresponding order for inclusion of the entry in the compilation.

16. The device according to claim 15, wherein said remote presentation system is a mobile presentation system.

17. The device according to claim 15, wherein said entry generator is configured to fill an entry field associated with an entry template with a customer-specific value if the customer specific value is defined from the customer data record, or else to allocate a standard value to the entry field.

18. The device according to claim 15, wherein said selection module is configured to display a number of search terms supplied from a terminology memory for additional selection, and to take account of each selected search term in the order.

19. The device according to claim 15, which further comprises a price calculation module configured to calculate price details for each entry prototype on a basis of a stored cost table.
